(19) United States
(12) Patent Application Publication
(10) Pub. No.: US 2012/0259551 A1
(43) Pub. Date: Oct. 11, 2012

(54) MEASUREMENT OF INVASION DEPTH WHILE DRILLING UTILIZING STREAMING POTENTIAL

(75) Inventor: Vladimir Valentinovich Shelukhin, Novosibirsk (RU)

(73) Assignee: BAKER HUGHES INCORPORATED, Houston, TX (US)

(21) Appl. No.: 13/413,810

(22) Filed: Mar. 7, 2012

(30) Foreign Application Priority Data
Sep. 7, 2001 (RU) PCT/RU2011/000683

(51) Int. Cl. G01V 3/18; G06F 19/00

(52) U.S. Cl. 702/7

(57) ABSTRACT

A system for determining an invasion depth of an invaded zone surrounding a borehole while the borehole is being drilled includes a sensor configured to be disposed in a mud cake formed on a wall of the borehole and configured to measure a property of the mud cake and a computing device configured to receive a measurement from the sensor and determine the invasion depth based on the measurement.

### CROSS-REFERENCE TO RELATED APPLICATIONS AND PRIORITY CLAIM

This application claims the benefit of PCT Application No. PCT/RU2011/000683, entitled “MEASUREMENT OF INVASION DEPTH WHILE DRILLING UTILIZING STREAMING POTENTIAL”, filed Sep. 7, 2011, which is incorporated herein by reference in its entirety.

### BACKGROUND

1. Field of the Invention

The present invention generally relates to drilling and, in particular, to determining invasion depth while drilling.

2. Description of the Related Art

Boreholes are drilled deep into the earth for many applications such as carbon dioxide sequestration, geothermal production, and hydrocarbon exploration and production. In all of the applications, the boreholes are drilled such that they pass through or allow access to a material (e.g., a gas or fluid) contained in a formation located below the earth's surface. Many different types of tools and instruments may be disposed in the boreholes to perform various tasks and measurements. One type of measurement that is typically made is a resistivity measurement.

Resistivity measurements can be made in several different manners. Regardless of how made, the measurements generally describe the electro-chemical content of the pore space of the formations surrounding the borehole. These measurements can be used to determine, for example, a desired direction of drilling.

While drilling it is customary to pump a drilling mud into the borehole to carry cuttings and other debris away from the bottom of the borehole. The mud is provided from the surface through the drill string and comes back to the surface in the area between the drill string and the sides of the borehole. The mud outside of the drill string shall be referred to herein as the “mud column.”

In borehole drilling, an over-balance between the pressure of the mud column and the formation can lead to mud filtrate invasion into pores of the rock defining the formation. The depth to which the mud invades the formation is referred to herein as “invasion depth.” Invasion can effect resistivity measurements and an understanding of the invasion depth is important for correctly interpreting resistivity-logging data.

### BRIEF SUMMARY

Disclosed is a system for determining an invasion depth of an invaded zone surrounding a borehole while the borehole is being drilled. This system includes a sensor configured to be disposed in a mud cake formed on a wall of the borehole and configured to measure a property of the mud cake and a computing device configured to receive a measurement from the sensor and determine the invasion depth based on the measurement.

Also disclosed is a method of estimating an invasion depth of an invaded zone surrounding a borehole while the borehole is being drilled. This method includes receiving information from a sensor disposed in a mud cake formed on a wall of the borehole; and determining at a computing device the invasion depth from the information.

### BRIEF DESCRIPTION OF THE DRAWINGS

The following descriptions should not be considered limiting in any way. With reference to the accompanying drawings, like elements are numbered alike:

FIG. 1 is a cut-away side view of a borehole that includes a mud cake formed on outer walls thereof and illustrates inversion and virgin zones in the formation;

FIG. 2 is a graphical representation of the relationship between a measured streaming potential and an invasion depth under different sets of conditions as a first overbalance pressure; and

FIG. 3 is a graphical representation of the relationship between a measured streaming potential and an invasion depth under different sets of conditions as a different overbalance pressure; and

FIG. 4 is a flow chart of a method according to one embodiment.

### DETAILED DESCRIPTION

A detailed description of one or more embodiments of the disclosed apparatus and method presented herein is by way of exemplification and not limitation with reference to the Figures.

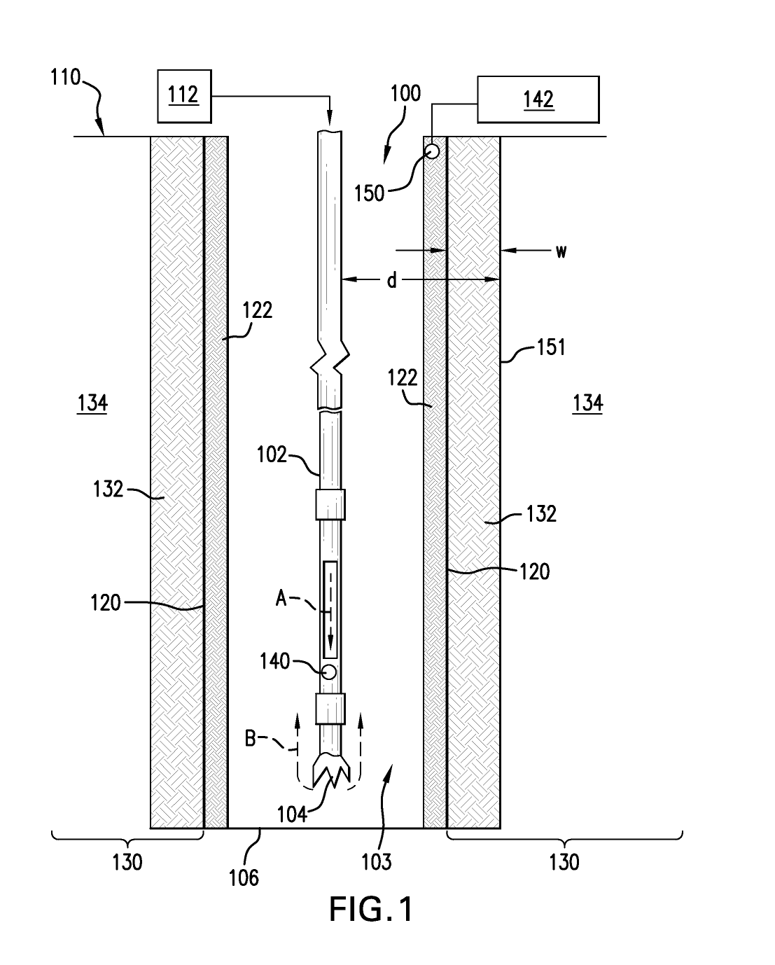

FIG. 1 shows a borehole 100 that is drilled by a drill string 102. The drill string 102 includes a drill bit 104 that is rotated by either rotation of the drill string 102 itself or by a motor (not shown) included in the drill string 102. The drill bit 104 pulverizes rock at the bottom 106 of the borehole 100 to elongate the borehole 100. It shall be understood that several implements located at the surface 110 are included to cause rotation of the drill bit 104. As such implements are well known, they are not discussed further herein. However, for a clearer understanding of embodiments disclosed herein one such implement in the form of mud pump 112 is illustrated. The mud pump 112 causes a drilling mud to be pumped into an internal portion of the drill string 102. At least some of the mud travels down the drill string 102 and exits it from a location in or near the drill bit 104. This downward travel is indicated by arrow A in FIG. 1. After the mud exits the drill sting 102 it travels back up the borehole 100 between the walls 120 of the borehole 100 and the drill string 102 as indicated by arrows B. In this manner, cuttings or other debris can be carried away from the bottom 106 of the borehole 100.

In some cases, the drilling mud forms a filter or mud cake 122 on the walls 120 of the borehole 100. The mud cake 122 can help reduce or prevent invasion of the drilling mud into the formation 130 surrounding the borehole 100. However, the formation 130 can include at least a portion of where drilling mud has invaded into it. In FIG. 1, such a region is shown as invaded zone 132. The invaded zone 132 has a width (w) that extends between the walls 120 of the borehole 100 and a virgin zone 134 that has not been invaded by mud. The area 103 between the drill string 102 and the mud cake 122 defines the mud column described above. For ease of explanation, reference numeral 103 will generally refer to the mud column.

The drill string 102 can also include a resistivity sensor 140. The resistivity sensor 140 can be any type of sensor that measures the resistivity of the formation 130. In one embodiment, the resistivity sensor 140 can provide resistivity measurements while drilling to a computing device 142. In another embodiment, the measurements are provided to the computing device 142 after drilling has stopped. Regardless, the computing device 142 can include programming or hardware that allows it to process the resistivity measurements to produce, for example, a resistivity log. It shall be understood that the sensor 140 could be included in a wireline tool (not shown) rather than as part of the drill string 102. In such a case, the drill string 102 is removed and the wireline tool lowered into the borehole 100 to take resistivity measurements. Regardless of how made, the resistivity measurements can be affected by the invasion depth (d) of the invaded zone 132. In FIG. 1, and elsewhere herein, the invasion depth (d) is defined as the distance from the drill string 102 to the virgin zone 134. Of course, the invasion depth could be defined in other manners without departing from the teachings herein. For example, the width w of the invaded zone 132 could be used to define the invasion depth in an alternative embodiment.

According to one embodiment, a sensor 150 is placed in the mud cake 122. The sensor 150 can be any type of sensor that can measure an electrical property of the mud cake 122. In one embodiment, the sensor 150 is a voltage sensor and measures the streaming potential of the mud cake 122. In one embodiment, the sensor 150 is located at or near the surface 110. As described further below, the streaming potential of the mud cake 122 can be used to estimate the invasion depth d.

In more detail, an electrokinetic phenomena, known as electroosmosis effect, can be utilized to correlate invasion depth to a streaming potential (e.g. voltage) measured by the sensor 150. Pressure in the mud column causes a pressure gradient along the mud cake 122. The gradient causes, according to the electroosmosis effect, ions to flow in the mud cake 122. The flow of ions, in turn, induces an electric field in the formation 130. The strength of this field depends strongly on the invasion depth d. In particular, the invasion depth defines a front 150 where water can collect and, as such, form a zeta-potential jump at the front 151 of the invasion zone 132. That is, the potential at the front 151 can result in a voltage in the mud cake 122 that can be measured by the sensor 150. It has been discovered that the permeability of the mud cake 122 is an important factor in such a determination. One of ordinary skill will realize that permeability of the mud cake 122 can be determined based on the composition of the drilling mud being used. The hydrodynamic theory that captures both the mud-filtrate invasion and the mudcake building is known in the art. However, such theories are limited to low values (less than 0.6 mV) of the computed streaming potential at the surface and suffer from poor knowledge of the in-situ zeta-potential which is commonly used in calculation of the cross coupling coefficient L in the generalized Darcy law. The Darcy law follows the general form as shown in Equation (1):

$$q = - \frac{k}{η} ∇ p - L ∇ ψ \qquad ( 1 )$$

where q is Darcy's velocity, k is permeability, η is viscosity, ψ is electric (streaming) potential, and L is the electrokinetic coupling term (e.g., cross coupling term). Assuming negligible ion diffusion and applying a two-scale homogenization approach L can be expressed as shown in Equation (2):

$$L = \frac{1}{F} \sqrt{\frac{k {σ}_{r}}{η}} \qquad ( 2 )$$

where σᵣ is the conductivity of the saturated rock and F is a dimensionless scaling factor on the order of 10³. As for σᵣ, it can be determined by the Archie law as shown in Equation (3):

$${Φ}^{m} = \frac{{σ}_{r}}{{σ}_{f}} \qquad ( 3 )$$

where σ_{f} is the conductivity of the pore fluid, Φ is porosity and m is the cementation factor.

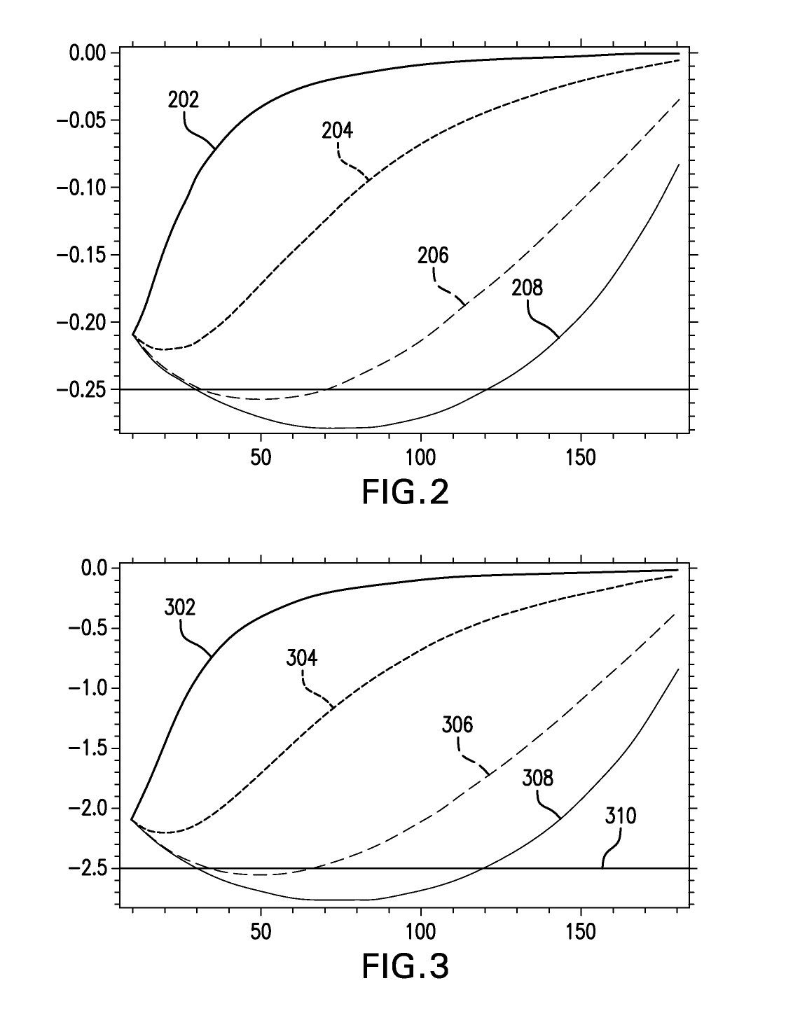

FIG. 2 illustrates several relationships between a calculated streaming potential in volts (y-axis) and the invasion depth in centimeters (x-axis). These relationships result from numerical solving of the ion transport equation div J=0 jointly with the fluid mass conservation equation div q=0, where J=−L∇p−σ, ∇ψ is the ionic flux. All the coefficients L, σᵣ, k, η undergo jumps across the invasion front, and the both the pressure p and the streaming potential ψ are sensitive to the invasion depth. In all cases, a drilling overbalance pressure of 2.0 bar is assumed. The traces 202, 204, 206 and 208 relate streaming potential to invasion depth for mud cakes having permeabilities of 0.01 mD, 0.1 mD, 1.0 mD and 10.0 mD, respectively.

FIG. 3 illustrates several relationships between a measured streaming potential in volts (y-axis) and the invasion depth in centimeters (x-axis) and the relationships were calculated in the same manner as those in FIG. 2. In all cases, a drilling overbalance pressure of 20.0 bar is assumed. The traces 302, 304, 306 and 308 relate streaming potential to invasion depth for mud cakes having permeabilities of 0.01 mD, 0.1 mD, 1.0 mD and 10.0 mD, respectively.

A comparison of FIGS. 2 and 3 indicates that increases in the pressure overbalance by an order of magnitude results in roughly the same order of magnitude increase in measured voltage.

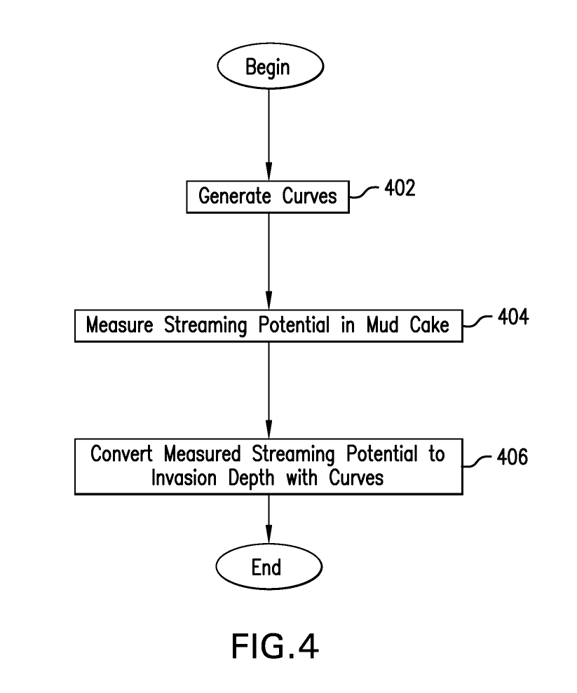

FIG. 4 is a flow chart illustrating a method according to one embodiment. In this embodiment, it is assumed that the conductivity, permeability and fluid viscosity in the mud cake, the invaded zone and the virgin zone are known. Given these values, curves as shown in FIGS. 2 and 3 can be generated as indicated at block 402 if the overbalance level is known. At block 404 a sensor is used to measure the streaming potential (e.g., voltage) in the mud cake at or near the surface. At block 406, the measured voltage is converted to an invasion depth using the curves formed in block 402. It shall be understood that the solution may not be unique. For example, in FIG. 3, a measured streaming potential of −2.5V indicates two solutions from trace 308 (30 and 120 cm) as indicated by line 310. In such a case, repeating the measurement at a later time will most likely give a different result. If the voltage decreased, it is most likely the 30 cm solution because, as is seen from trace 308, a small increase of invasion depth (close to 30 cm) results in the voltage decrease, and a small increase of invasion depth (close to 120 cm) results in the voltage increase.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second,” and “third” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for determining an invasion depth of an invaded zone surrounding a borehole while the borehole is being drilled, the system including:
a sensor configured to be disposed in a mud cake formed on a wall of the borehole and configured to measure a property of the mud cake; and
a computing device configured to receive a measurement from the sensor and determine the invasion depth based on the measurement.

2. The system of claim 1, wherein the sensor is configured to measure a streaming potential of the mud cake.

3. The system of claim 1, wherein the sensor is configured to measure a voltage of the mud cake.

4. The system of claim 1, further comprising:
a drillstring including a sensor to measure a downhole property of the borehole.

5. A system for determining an invasion depth of an invaded zone surrounding a borehole while the borehole is being drilled, the system including:
a sensor disposed in a mud cake formed on a wall of the borehole and configured to measure a property of the mud cake; and
a computing device that receives a measurement from the sensor and determines the invasion depth based on the measurement.

6. The system of claim 5, wherein the sensor is configured to measure a streaming potential of the mud cake.

7. The system of claim 5, wherein the sensor is configured to measure a voltage of the mud cake.

8. The system of claim 5, further comprising:
a drillstring including a sensor to measure a downhole property of the borehole.

9. The system of claim 5, wherein the borehole penetrates a surface of the earth and the sensors is disposed in the mud cake at or near the surface.

10. A method of estimating an invasion depth of an invaded zone surrounding a borehole while the borehole is being drilled, the method comprising:
receiving information from a sensor disposed in a mud cake formed on a wall of the borehole; and
determining at a computing device the invasion depth from the information.

11. The method of claim 10, wherein the information is a streaming potential of the mud cake.

12. The method of claim 10, wherein the information is a voltage of the mud cake.
